(19) United States
(12) Patent Application Publication
(10) Pub. No.: US 2007/0244996 A1
(43) Pub. Date: Oct. 18, 2007

(54) Web enabled exchange server standby solution using mailbox level replication

(75) Inventors: Bilal Ahmed, San Jose, CA (US); Aby Mathew, Campbell, CA (US); Adnan Khan, San Jose, CA (US); Matthew W. Wahlin, Palo Alto, CA (US); Thirumalai Srinivasan, San Jose, CA (US)

Correspondence Address: W. Patrick Kelley, Sr.;the CITY HOTEL, Suite F, 145 South Washington Street, Sonora, CA, 95370, US

(73) Assignee: Sonasoft Corp., A California Corporation

(21) Appl. No.: 11/404,410

(22) Filed: Apr. 14, 2006

(51) Int. Cl. G06F 15/177

(52) U.S. Cl. 709/220

(57) ABSTRACT

This invention provides the capability to plan, monitor and control post-failure switching of user mail access hosted on Microsoft Exchange servers at the granularity of individual user mailboxes. It offers a convenient point-and-click mechanism for achieving a very complex task, and allows replication of e-mail data from a Primary Exchange Server to a Standby Exchange Server at a level of data granularity and flexibility not previously available. No limitations are placed on which Exchange servers belonging to the user of this solution are to be in a primary or standby role, and it is possible to have two Exchange servers, each acting as an active primary for mailboxes which it is hosting AND acting as a standby for mailboxes hosted on the other server. In addition, it also provides a uniquely powerful capability for migration of mailboxes between Exchange servers.

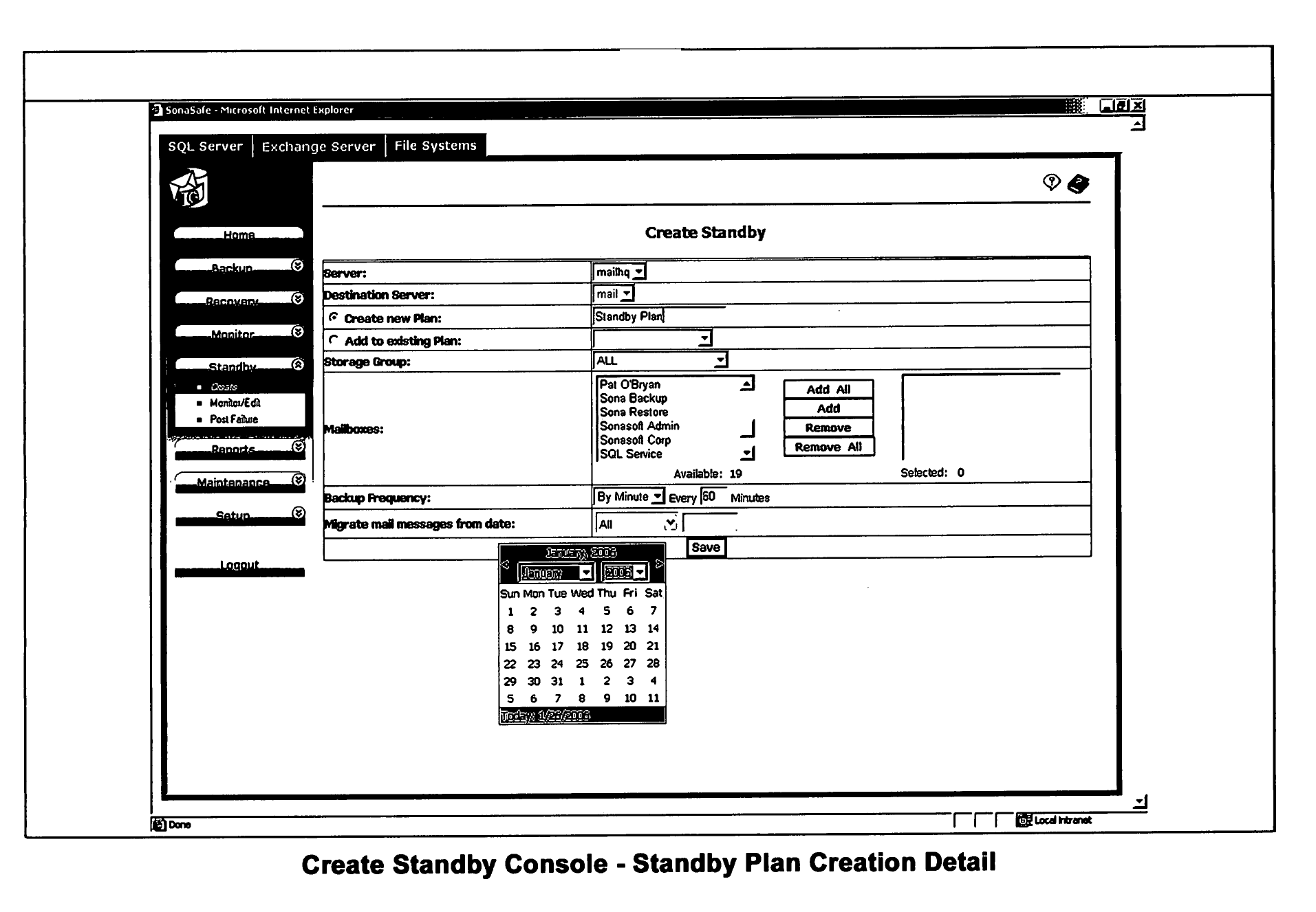

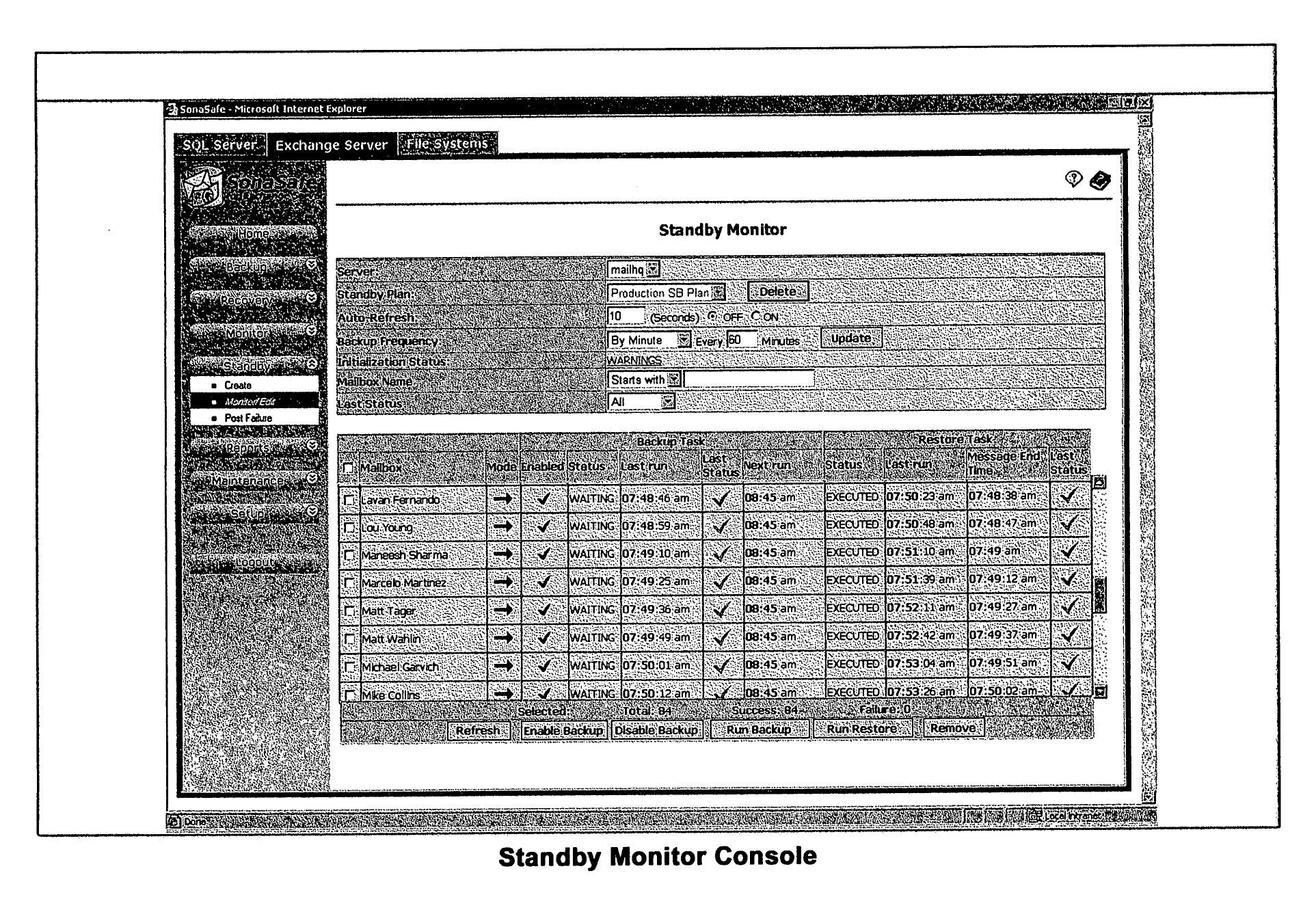

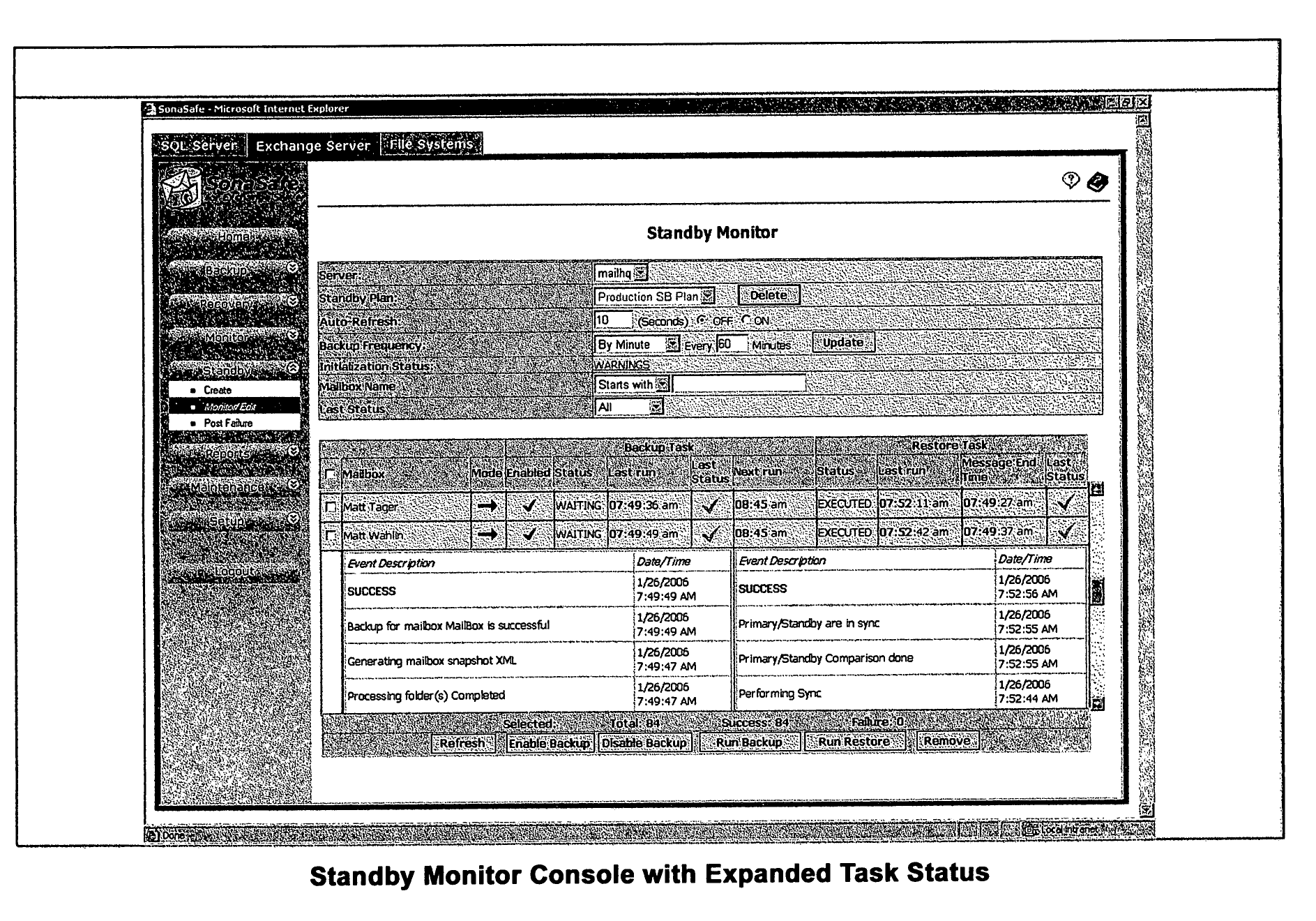

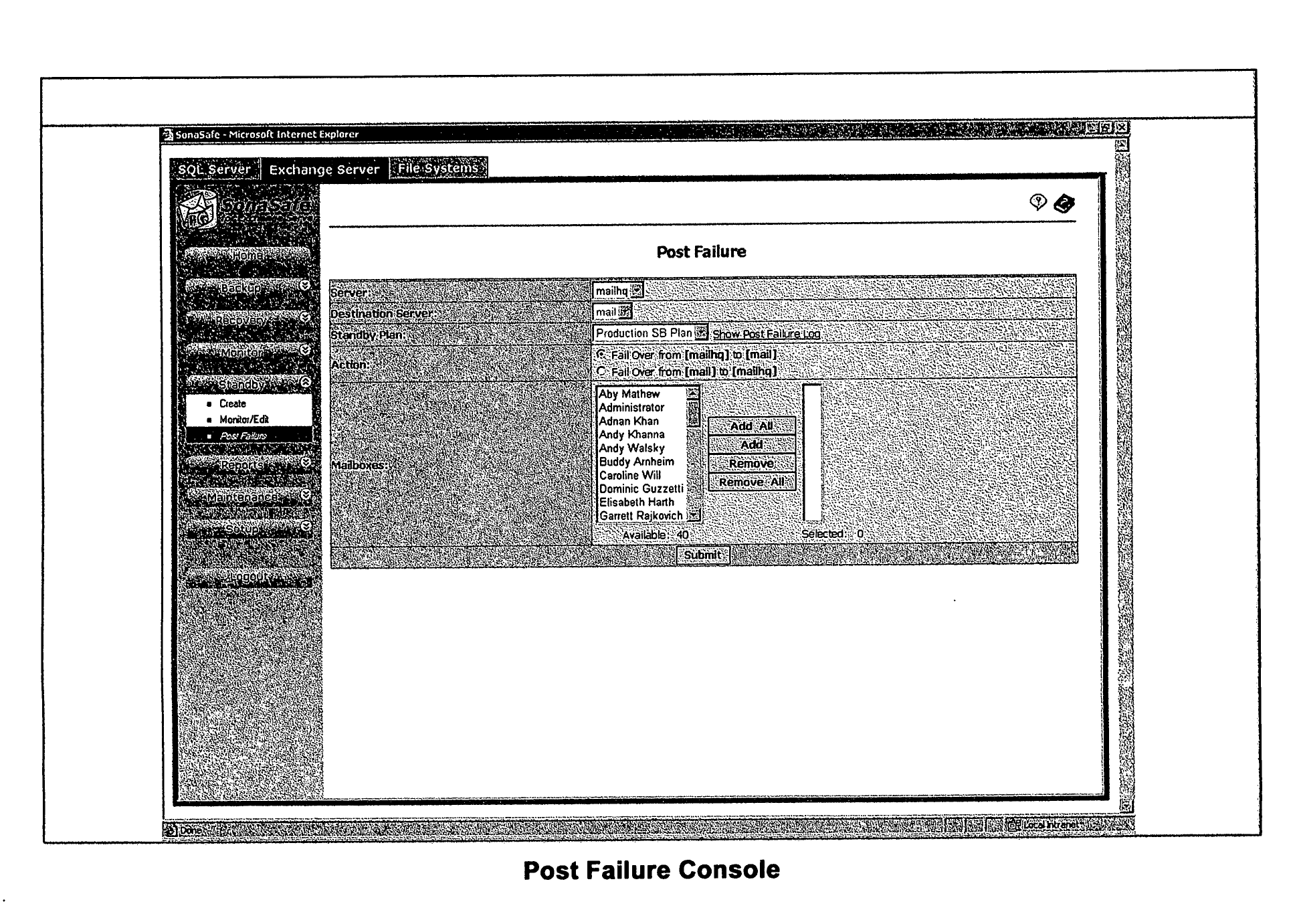

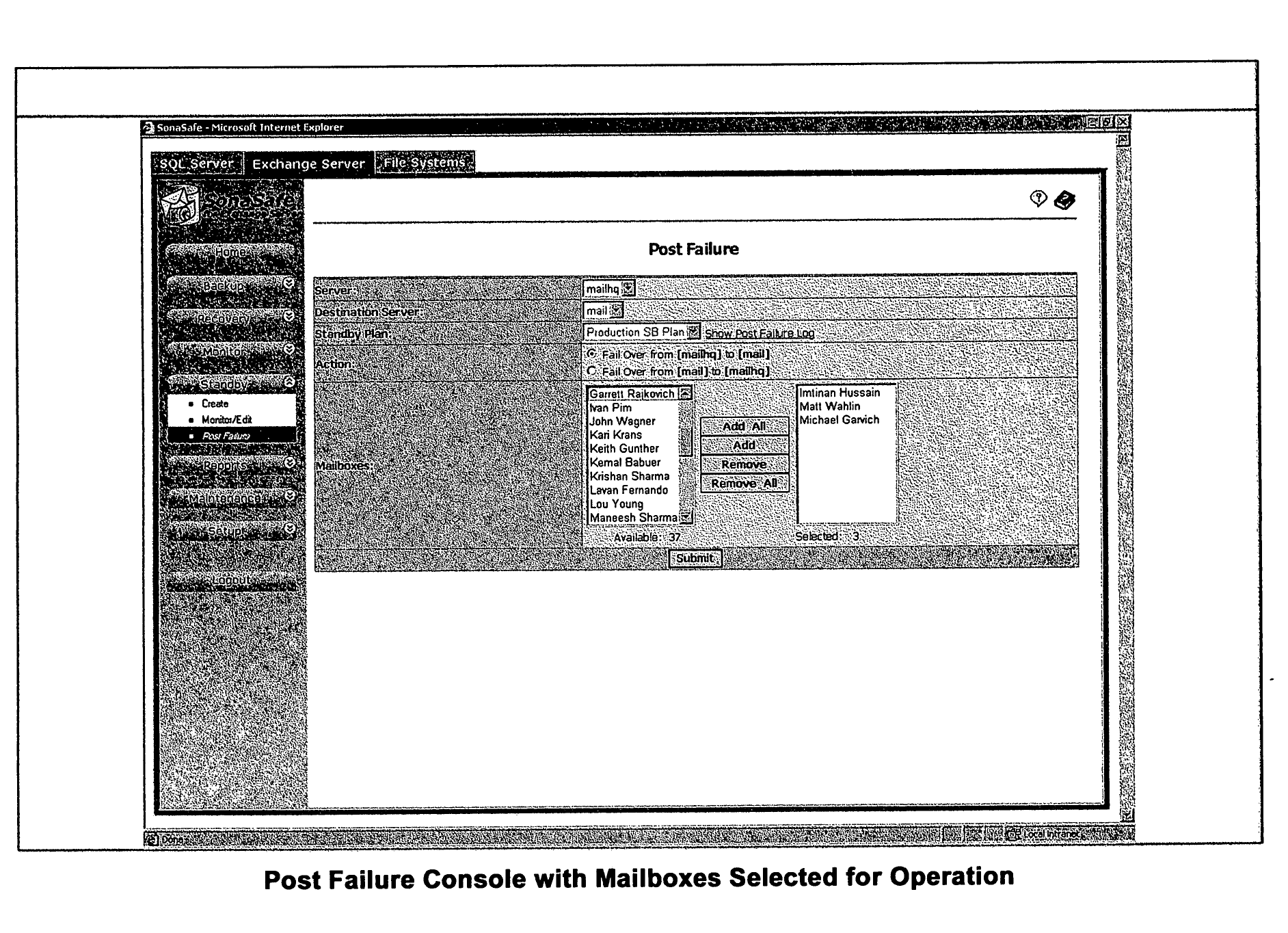

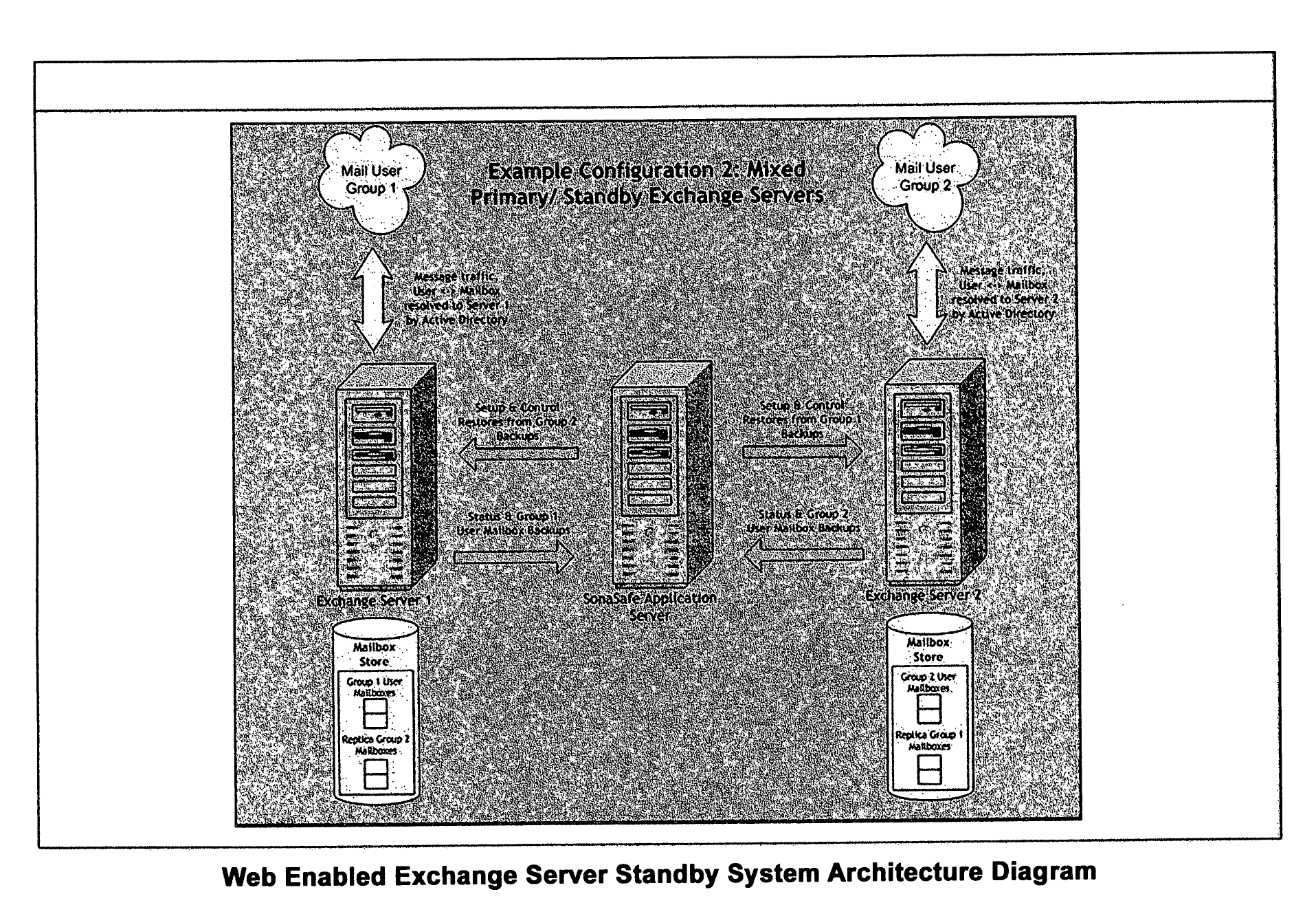

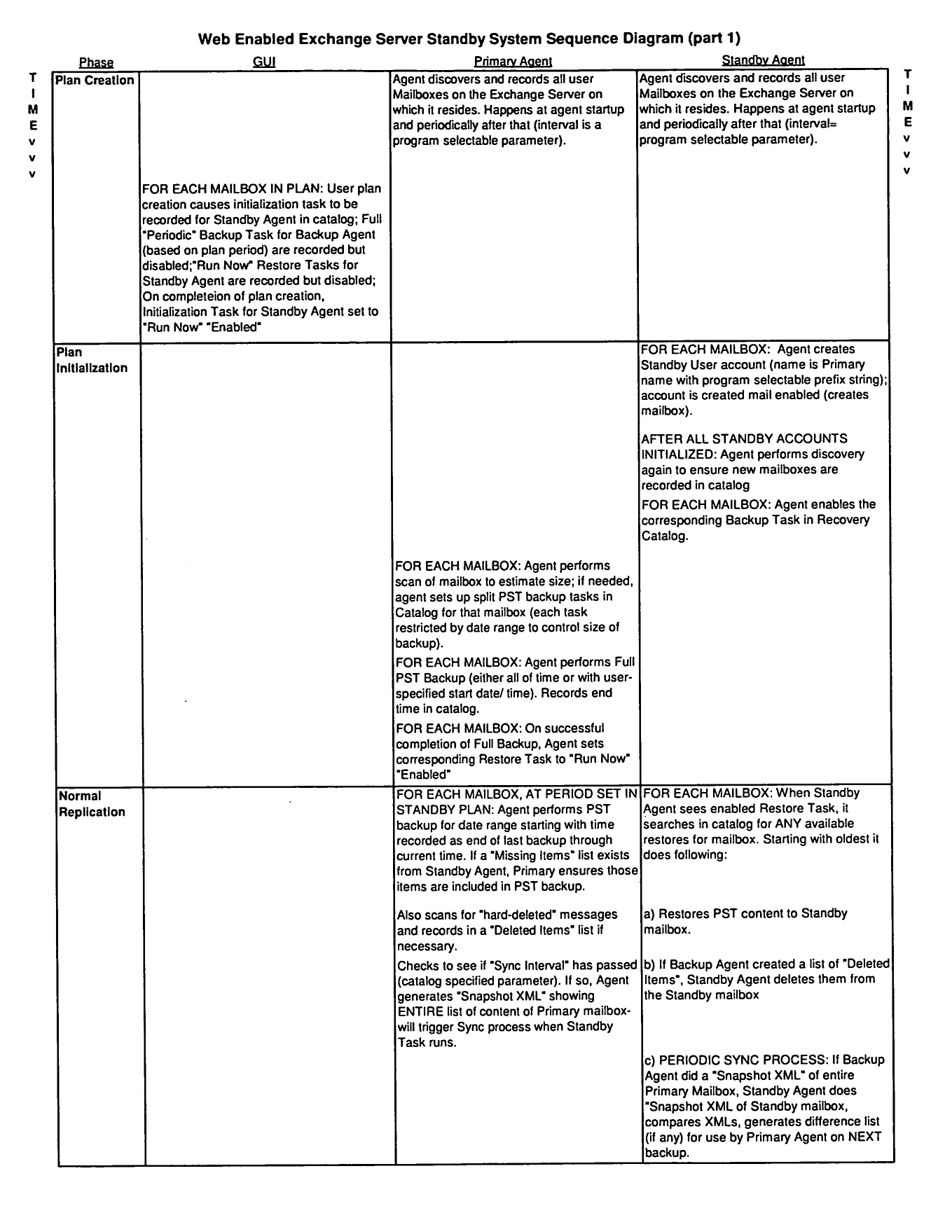

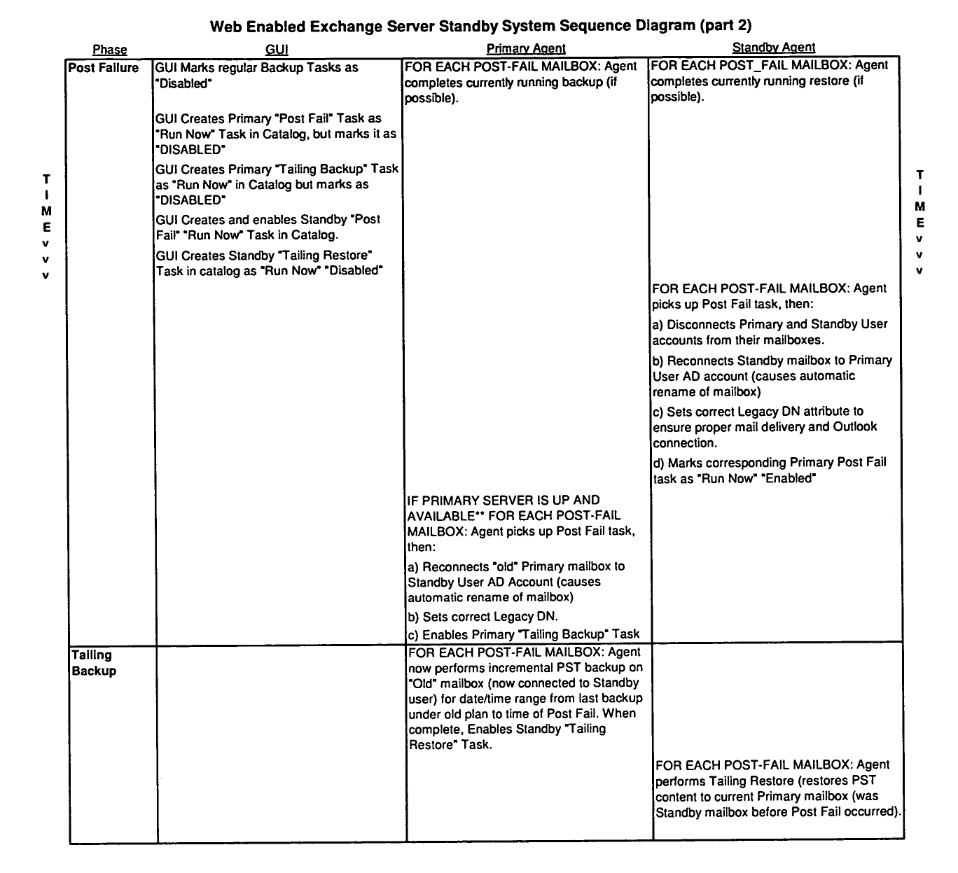

### CROSS-REFERENCE TO RELATED APPLICATIONS

Not applicable.

### STATEMENT REGARDING FEDERALLY SPONSORED RESEARCH OR DEVELOPMENT

The invention described in this Non-Provisional Patent Application (Web Enabled Exchange Server Standby Solution Using Mailbox Level Replication) has been developed entirely without federally sponsored research and development funds.

### REFERENCE TO SEQUENCE LISTING, A TABLE, OR A COMPUTER PROGRAM LISTING COMPACT DISC APPENDIX

Not applicable.

### BACKGROUND OF THE INVENTION

The creation of an Web Enabled Exchange Server Standby Solution Using Mailbox Level Replication was inspired by the demand for a robust standby solution in a Microsoft Exchange 2000 or later e-mail Server context, which can exist on the same network as a production (or “primary”) Exchange server and which provides the capability to plan, monitor and control post-failure switching of user mail access at the granularity of individual Exchange user mailboxes. The invention needed to be cost-effective, flexible and utilize software and hardware typical of, and compatible with, common computer systems and networks based on Microsoft's Windows operating system. In the event of a production Microsoft Exchange server failure, the consequences to a business can be disastrous, and can cascade through all areas of the business including engineering, marketing, finance and especially sales which relies on emails for orders. Business would come to a grinding halt with indefinite downtime, which translates into loss of revenue. Currently, no user-friendly standby solution exists in a Microsoft Exchange Server context with the standby Exchange server existing on the same network as the primary Exchange server and providing the capability to plan, monitor and control post-failure switching of user mail access at the granularity of individual Exchange user mailboxes. Existing workarounds for standby involve the cumbersome process of taking full and incremental backups of the production Exchange server and moving those backups to the standby server located on a different network and then performing the restore, which in addition to being very detailed, is often an unreliable, slow and not easily automated process. In addition, currently existing software solutions for creating an Exchange Server Standby solution depend on doing data transfers at a file or disk block level—as such they are very susceptible to replicating corrupted data to the Standby and are unable to filter out data corruption at the level of individual mailboxes or mail messages, including data corruption due to email viruses.

The Web Enabled Exchange Server Standby Solution Using Mailbox Level Replication invention described in this application avoids these pitfalls, as it is inherently focused on selectively replicating changes on the level of email messages in individual mailboxes—when corrupted messages are filtered or removed on the production Exchange server these changes or deletions will be replicated to the Standby server much more quickly and efficiently than they will be by a solution operating at a less precise data level. As such, this system provides for increased system reliability and availability for critical business data processing systems, and should fall under the definition for U.S. patent Classification Class 714, “Error Detection/Correction and Fault Detection/Recovery”, subclass 100 “Data Processing System Error or Fault Handling”, subclass 1 “Reliability and Availability”, as the Web Enabled Exchange Server Standby Solution Using Mailbox Level Replication “increase(es) (the) probability of correctly performing services (e.g., data processing) throughout a time interval, given correct performance at the beginning of the interval” AND “increase(es) the probability of correctly performing services at any given instant”.

In addition, the Web Enabled Exchange Server Standby Solution Using Mailbox Level Replication provides a user with a flexible option for migration of user mailbox data from an older Microsoft Exchange Server 2000 system to a newer Microsoft Exchange Server 2003 system, providing a high degree of process automation, but allowing for the flexibility of migrating either individual mailboxes or groups of mailboxes, verifying the success of the migration operation(s) and switching of mailbox operations to the new Exchange 2003 Server, all with minimal interruption or downtime for user mail operations. Existing solutions for Exchange migration tend to rely on use of migration tools requiring significant amounts of manual intervention, suffer from limitations of how much data can be transferred (typically limited to 2 Giga-Bytes per mailbox), and often require significant (and expensive) consulting services to implement properly. The Web Enabled Exchange Server Standby Solution Using Mailbox Level Replication described in this application provides a more automated solution, is not limited as to the size of mailboxes which can be transferred and will provide significant cost savings over currently existing migration solutions. The inherent capability to replicate and migrate data at the level of individual mailboxes also offers substantial advantages for an organization utilizing Microsoft Exchange in terms of easily migrating mailboxes for groups of email users should they relocate geographically (such as when a corporation or government agency opens a new office)—this also gives the administrators responsible for implementation of an organization's Exchange email architecture significantly improved flexibility in balancing processing loads between servers within their organization. In addition, the ability to easily switch user mailbox access from a primary to a standby Exchange server with a single click of a mouse and then switch it back again with another mouse click, all without impact to the email user, provides an Exchange administrator unprecedented flexibility for operations such as performing maintenance or upgrades on their servers.

As such, this additional use for the system provides for enhanced software upgrading or updating capabilities for the Microsoft Exchange Server email data processing system, and should fall under the definition for U.S. Patent Classification Class 717 “Data Processing: Software Development, Installation and Management”, subclass 168 “Software Upgrading or Updating”, as the Web Enabled Exchange Server Standby Solution Using Mailbox Level Replication “compris(es) means or steps for modifying an existing operating system, application program, or other executable program, in order to produce an upgraded or updated program” (in this case an updated Exchange email Server system).

### PRIOR ART

The following Prior Art should be distinguished from the present application in that it does not contain the features and functionality described above and/or it does not relate specifically to Microsoft Exchange Server:

U.S. Patent Documents

| | | | |
|---|---|---|---|
| (1) | 5742792 | April, 1988 | Yanai et al. |
| (2) | 6338126 | January, 2002 | Ohran et al. |
| (3) | 6502205 | December, 2002 | Yanai et al. |
| (4) | 6560617 | May, 2003 | Winger et al. |
| (5) | 6708283 | March, 2004 | Nelvin et al. |
| (6) | 6763436 | July, 2004 | Gabber et al. |
| (7) | 6785786 | August, 2004 | Gold et al. |
| (8) | 6820098 | November, 2004 | Ganesh et al. |
| (9) | 6928580 | August, 2005 | Pedone et al. |
| (10) | 6980988 | December, 2005 | Demers et al. |
| (11) | 6996629 | February, 2006 | Odenwald |
| (12) | 7003694 | February, 2006 | Anderson, Jr. et al. |

### BRIEF SUMMARY OF THE INVENTION

The creation of a Web Enabled Exchange Server Standby Solution Using Mailbox Level Replication was inspired by the demand for a robust standby solution in a Microsoft Exchange Server context, which can exist on the same network as the production (or “primary”) Exchange server and which provides the capability to plan, monitor and control post-failure switching of user mail access at the granularity of individual Exchange user mailboxes. Sonasoft offers a convenient, easy to use, point-and-click mechanism for achieving a relatively complex task. The design for the user interface consists of three consoles: Create Standby, Standby Monitor and Post Failure; It is in the Create Standby console that servers are assigned either a primary or secondary role for an operational plan, Mailboxes are selected for replication from the primary to the standby exchange server from a list of mailboxes currently hosted on the primary, a replication interval and optional replication start date and time are specified, and operation of the plan is initiated. In addition, no limitations are placed on which Exchange servers belonging to the user are to be in a primary or standby role, and it is possible to have two Exchange servers, each acting as an active primary for mailboxes which it is hosting AND acting as a standby for mailboxes hosted on the other server. The Standby Monitor console allows a user to monitor the status of mail replication at the level of individual mailboxes for any defined plan for a selected primary exchange server, and allows a user to selectively suspend or restart mail replication operations; information on this console is presented in an easy-to-read summary form, with a one-click interface to allow a user to ‘drill down’ to more detailed status information. The Post Failure console allows a user to select a primary Exchange server, select a defined standby plan for that server, and then selectively switch mail delivery and user access for any mailboxes contained within the plan from the primary to the standby server. This process can be initiated from the Post Failure console at any time after initiation of a plan and is not dependent on whether the primary Exchange server is still operational; in addition, it allows the user to selectively post-fail anywhere from a single mailbox to all of the mailboxes contained within the plan with a single click, and requires no further user intervention after that point to bring the mailboxes to a full operational status.

A secondary use for the Web Enabled Exchange Server Standby Solution Using Mailbox Level Replication is to provide enhanced capabilities for migration of user mail from existing Microsoft Exchange Server systems to other Microsoft Exchange Server systems with a high degree of flexibility and ease of use, coupled with minimal downtime for users of the Exchange email system. This migration of mailboxes can be achieved easily by establishing an operational standby plan, letting the software perform the automatic replication of mailbox contents to the Standby Microsoft Exchange Server and then performing the Post Failure operation for the mailboxes, which will then reside on the ‘new’ or upgraded Microsoft Exchange Server. The ease with which mailbox operations can be switched back-and-forth between servers also allows significantly improved capabilities in the areas of balancing processing loads between servers within an organization, and provides added flexibility for routine Exchange server maintenance and upgrade operations.

### BRIEF DESCRIPTION OF THE SEVERAL VIEWS OF THE DRAWING

The following table lists the figures included with this Non-Provisional Utility Patent Application for a Web Enabled Exchange Server Standby Solution Using Mailbox Level Replication.

| FIG. | Description |
|---|---|
| 1 | Create Standby Console - Standby Plan Creation Detail |
| 2 | Standby Monitor Console |
| 3 | Standby Monitor Console with Expanded Task Status |
| 4 | Post Failure Console |
| 5 | Post Failure Console with Mailboxes Selected for Operation |
| 6 | Web Enabled Exchange Server Standby System Architecture |
| | Diagram |
| 7 | Web Enabled Exchange Server Standby System Sequence |
| | Diagram (part 1) |
| 8 | Web Enabled Exchange Server Standby System Sequence |
| | Diagram (part 2) |

### DETAILED DESCRIPTION OF THE INVENTION

Sonasoft offers an appliance server-based solution (SonaSafe for Exchange Standby), which automates the process of mailbox backups; backups are backed up to the appliance server (offering a disk-to-disk solution, thereby eliminating tape), and restore operations are initiated directly from the appliance server, eliminating any need for data transfers by users. Agent software installed on the primary Exchange server(s) performs full or incremental mailbox backups in accordance with a plan established on the appliance server; agent software on the standby Exchange server(s) handles creation of shadow mailboxes on the server and restoration of backup data into them. The agent software is tightly integrated with Microsoft's Exchange and Active Directory software, providing maximum performance and flexibility in how mail backups and restores are performed. The console design for the system consists of three web accessible consoles: Create Standby, Standby Monitor which allow the user complete control of the definition and operation of backup and restore operations for anywhere from a single Exchange mailbox to thousands of mailboxes with a simple mouse-based point and click interface, and Post Failure, which allows the user to selectively switch mailboxes in a post-fail situation, initiating the switchover of selected mailboxes with a single mouse click. The following text describes the detailed user-level interaction with the graphical user interface in the three consoles—it is followed by a section describing the underlying design and data flow of the systems implementing the actions requested via the three consoles.

Create Standby Console: The Create Standby console allows a user to establish the relationship between a Primary and Standby Exchange Servers.

The first steps in the Standby Creation process are to select the names of the Exchange Server to be replicated (the Primary) and the Exchange Server which will receive the replicated mailboxes (the Standby). This causes the selection list under Mailboxes to populate with the list of all mail-enabled users for which standby replication has not already been set up; the first time you create a standby plan, this should be all mail enabled users. (This feature makes it easy for the user to recognize new users which have been added after standbys were set up—it can also be used to detect users with Active Directory logins which do not have mailboxes established.) The user can further filter the mailboxes by selecting the Storage Group containing the mailboxes. This can be useful in the case where the user intends to create multiple Standby Plans with different schedules.

At this point, the user selects the mailboxes which are to be backed up on the Primary Exchange Server and restored on the Standby, using the Add All, Add, Remove and Remove All buttons.

The user now selects the Backup Frequency for mailbox replication in the plan. This time determines how frequently the SonaSafe Agent on the Primary server will check for changes to the mailboxes in the plan, create backups containing the changes and instruct the SonaSafe Agent on the Standby Server to load the content of those backups onto the Exchange Server. Choosing a shorter interval for the Backup Frequency will reduce the likelihood of lost messages in the event of a truly catastrophic failure of the Primary Exchange Server. The Backup Frequency can be specified as an interval of minutes, an interval of hours or as a 24-hour interval with a specific start time.

NOTE: During a Post-Failure switch from the Primary to the Standby Exchange Server, the SonaSafe for Exchange software attempts to recover all messages for the mailboxes which were not transferred by the normal Replication process—as a result, the time window set by the Backup Frequency setting really represents the maximum period of message loss should the hardware on the Primary Exchange Server become COMPLETELY unavailable.

The Migrate mail messages from date setting is used during initiation of a Standby Plan to determine how far back in the history of the replicated mailboxes messages are to be replicated. Normally, most users will select the default “All” setting instead of selecting a specific date and time from which to start message replication. Once this value has been selected, clicking the Save button will save the plan settings and initiate the Standby Replication process for all selected mailboxes.

Standby Monitor Console: The Standby Monitor console allows the user to monitor the current status of all the Replication tasks in a Standby Plan. Selecting the Primary Server in the first drop-down list then populates the Standby Plan list with all currently defined plans for that Primary. (Drawing 2 with this patent application illustrates operation of the Standby Monitor Console.)

A selected Standby Plan can be deleted by clicking the Delete button. The user can also modify the Backup Frequency for the Replication tasks in the plan by changing the displayed value and clicking the Update button. Note that deletion of a Standby Plan will not delete mail data which has been replicated to standby mailboxes on the Standby Exchange server—as such a user can flexibly re-establish a plan at a later time and resume operations replicating only changes since the time that the original plan was deleted.

The lower portion of the screen (the Task Status display) shows the list of Mailbox Replication tasks included in the plan, with status displayed for each of the two separate components of the Replication: the Backup Task on the Primary Exchange Server, and the Restore Task on the Standby Exchange Server. Note that these two tasks are displayed as a unit because Restore Task(s) on the Standby are automatically initiated by the completion of the associated Backup Task(s) on the Primary. The user can selectively Enable or Disable backups on a per-mailbox basis (and hence the associated restores); in addition, the user can use the Run Restore button to force a selected restore task or tasks to run. The various display fields (Status, Last Run, Last Status, and Next Run) allow the user to monitor detailed progress of the execution of each Replication task. In addition, clicking on the Last Status indicator for any Backup or Restore task on the Standby Monitor screen will cause it to display the detailed execution logs for the most recent run of that task immediately below the Replication Task status line in the display.

NOTE: Normally, a user will only disable tasks in the case where a mailbox is known to contain data which you do NOT want replicated to the Standby Exchange Server (such as virus software content). This feature would be seldom used, because removal of infected messages on the Primary will automatically be reflected on the Standby by normal Replication. The Run Restore button would normally only be used if the Standby Exchange Server had been unavailable for a long period—it would cause the Agent on the Standby Server to immediately begin catching up with backlogged Restore Tasks. Disabling and Enabling a Backup task will never result in a loss of data since the Agent always checks for all change data since the last completed Replication. (Drawing 3 with this patent application illustrates operation of the Standby Monitor Console with Expanded Task Status.)

The display of detailed status data for Replication Tasks on the Standby Monitor console screen can be made to update in either of two manners. The user may manually refresh the data on the screen by clicking on the Refresh button at the bottom of the Task Status display, or the user may turn on Auto-Refresh at the top of the screen with a selected refresh interval (in seconds).

Post Failure Console: The Post Failure console is where a user can initiate the transfer of operations for a mailbox or set of mailboxes being replicated by a Standby Plan from a Primary Exchange Server to a Standby Exchange Server. Once the Post Failure operation has been completed, logins and accesses by the mail user associated with the mailbox on the Primary server will be switched to the mailbox on the Standby Exchange Server. In addition, the SonaSafe for Exchange Server software will attempt to replicate any changes to the user's mailbox which have occurred since the last normal standby Replication Task execution for that mailbox (if the Primary Exchange Server is physically accessible on the network and the SonaSafe for Exchange Agent is running on it).

NOTE: During the Post Failure process each mail user's mailbox which is being switched will be temporarily unavailable for a short period—if the mail user was accessing their mail account at the time of the switch, they will also be required to log out of their mail account and log back in to be able to properly access their mail. The mail user will typically be able to log back in to their email account almost immediately after the Post Failure switch is completed; replication of the final messages from the old mailbox to the new mailbox may take longer, depending on the number of messages remaining to be copied, which itself is usually dependent on the Backup Frequency the user selected at the time of Standby Plan creation.

To initiate a Post Failure, the user begins by selecting the Primary Server from the drop down menu, followed by selecting the Standby Destination Server; This will populate the Standby Plan drop-down menu with the full list of all Standby Plans which have been previously created to replicate mailboxes from that Primary to the target Standby. The following screen shot shows an example where the user has selected the two servers and the plan. (Drawing 4 with this patent application illustrates operation of the Post Failure Console.)

Once the servers and plan have been selected, the user can use the Add, Add All, Remove and Remove All buttons to select which mailboxes/users are to be switched from the Primary Exchange Server to the Standby Exchange Server.

NOTE: the ability to selectively switch mailboxes can be used as a migration tool for moving user mailboxes between Exchange Servers.

The user also has the option of clicking on the Show Post Failure Log link to show detailed status from prior Post Failure operations—this includes status from disconnecting mail users in Active Directory from mailboxes on the Primary Exchange Server and status from reconnection of the users to mailboxes on the Standby Exchange Server.

Please see drawing 5 with this patent application for illustration of an example where the user has selected three mailboxes out of the entire set of mailboxes in the selected plan for Post Failure switching.

Once the desired mailboxes have been selected, clicking the Submit button will initiate the Post Failure process for the selected mailboxes/users. All processes which follow from this point will be fully automatic and not require user intervention.

Description of underlying design and data flow of the systems implementing the actions requested via the three consoles:

Implementation of the Web Enabled Exchange Server Standby Solution Using Mailbox Level Replication is via a general system architecture consisting of the following elements:

A SonaSafe Application server which hosts the Graphical User Interface (GUI) for the invention and a database known as the Recovery Catalog which is used as a central point to record tasks to be performed along with status from tasks already performed. In addition to being accesses by the GUI software on the SonaSafe Application Server, the Recovery Catalog will be accessed by agents running on each Exchange Server. These agents have the responsibility for implementing the steps required to carry out a plan established through the GUI. Agents are registered with the Recovery Catalog and have the necessary logic to recognize those tasks which are germane to the server on which each agent resides. They also automatically perform the necessary actions to discover the list of mailboxes on each Exchange server and report these to the Catalog; this enables the GUI to properly display mailboxes which a user may choose to include in a Standby Plan.

Drawing 6 included with this patent application provides a diagram of the general Web Enabled Exchange Server Standby System Architecture. In this diagram, general information flows are represented by white arrows. The particular example shown is representative of a case where the Web Enabled Exchange Server Standby System has configured two Microsoft Exchange servers to each be an active Standby Server for mailboxes hosted on the OTHER Exchange Server.

Once an operator using the SonaSafe Application hosted on the SonaSafe Application Server uses the Create Standby Console to create a Standby Plan, the following series of actions occur for each mailbox included with the plan (please see Drawings 7 and 8 included with this patent application for a Web Enabled Exchange Server Standby System Sequence Diagram, part 1 and part 2):

The Standby Agent (i.e. the agent on the Exchange Server designated as the “Standby” in the plan) creates new “shadow” exchange users and mailboxes via Microsoft Active Directory based on the names of the user mailboxes which were selected in the GUI (where new names are created by pre-pending a configurable string to the start of the original, or “primary” user names).

Once the Standby Agent reports successful initialization to the SonaSafe Application Recovery Catalog, the Primary Agent (i.e. the agent on the Exchange Server which contains the user mailboxes to be replicated to the Standby Exchange Server) does the following:

The agent scans through the mailbox BEFORE performing a backup to estimate the total size of the data; if it determines that the size is greater than a limit configured with the software, it intelligently splits the backup into multiple .PST files, in order to guarantee that the files are smaller than the 2 Gigabyte size limit enforced by the Microsoft Exchange MAPI software for Exchange. Once the backup for a mailbox is completed, the Backup agent creates a Task in the Catalog for the Standby Agent to Restore. The backup also includes special information to allow proper processing of moved, copied and hard-deleted messages in the user mailbox being replicated.

The agent then performs either a FULL backup or DATE RESTRICTED backup (based on user selected settings during plan creation). The backup is stored in the form of a Microsoft .PST file, as defined by the standard Microsoft Exchange MAPI (Messaging Application Program Interface) and is performed entirely through calls to standard Microsoft Exchange MAPI routines. All Backups are written to .PST files via the network in a shared directory structure maintained on the SonaSafe Application server.

When the Primary Agent completes any mailbox backup (including the initial one), it completes the backup task with the following actions:

The agent records the time through which mail messages have been backed up for that mailbox in the Recovery Catalog on the SonaSafe server.

The agent schedules a task for the associated Standby Agent to restore the data into the associated mailbox on the Standby Exchange Server.

The agent then schedules the Backup task to run again for the mailbox after the replication time interval specified by the user for the plan in the Create Standby console. The task which is scheduled will be incremental, that is it will backup ONLY messages which have been added or changed in the Primary mailbox since the ending time recorded for the last successful backup.

Once it sees a Standby restore task to perform, the Standby Agent is responsible for taking backup .PST files and merging them into the Standby mailboxes created to hold copies of the Primary mailboxes; it also manages message deletions in accordance with message Move, copy or hard-delete information recorded by the Backup agent. It works from the information in the recovery catalog, and always begins with the OLDEST backup set which has not been marked in the catalog as having been restored on the Standby. Once a restore is verified as successful, BUT NEVER BEFORE THIS VERIFICATION HAS OCCURRED, the Standby agent marks the restore as successful in the catalog—this mechanism ensures that no data is ever lost due to unavailability of the Standby Exchange server; the agent will always work to ensure that ALL backup sets are restored in their proper order.

While performing these operations, both the Primary and Standby Agents write detailed status information back into the Catalog maintained on the SonaSafe Application Server; this provides the information shown to users in the Standby Monitor Console.

Replication occurs in this manner between the Backup and Standby Agents until such time that a user initiates a Post Failure via the Post Failure Console. When a post failure is initiated for any given mailbox, the Backup and Standby Agents do the following for that mailbox:

Complete any currently running backup/restore operations

Switch the user/mailbox relationships between the Primary and Standby Users and Mailboxes in Microsoft Active Directory, using standard Microsoft Active Directory Application Program Interface calls.

If the Exchange Server which hosted the original Primary mailbox is available (i.e. has not undergone an unrecoverable system failure) the agent on that server will also perform the following actions:

The old “Primary Agent” will reconnect the Standby User account with the OLD Primary mailbox.

The agent will then create a special backup containing any new or changed messages in that mailbox since the time of the last recorded successful backup; if this backup is non-empty, it will create a task for the agent on the other Exchange Server to restore those messages to the NEW “Primary” mailbox.

Finally, once any remaining data has been transferred, the agent will (based on a user-selectable option) cause standby operations to begin in the REVERSE direction, i.e. the OLD Primary Agent will now become the Standby Agent and vice versa.

What is claimed is:

1. The invention described in this application (Web Enabled Exchange Server Standby Solution Using Mailbox Level Replication) implements a unique solution for providing automatic replication of data between a Primary e-mail server operating the Microsoft Exchange 2000 (or later) system, which implements the user configuration, control and automatic replication of email data at an individual mailbox level.

2. The replication of data at the level of individual mailboxes provided by the Web Enabled Exchange Server Standby Solution Using Mailbox Level Replication will provide a much higher level of reliability than with currently available Standby solutions, as it significantly decreases the likelihood of replicating corrupted data between servers.

3. The invention described in this application (Web Enabled Exchange Server Standby Solution Using Mailbox Level Replication) provides a unique, easy-to-use Graphical User Interface, allowing users to create and control Standby Plans for mailbox replication in a simple and intuitive manner; in addition, basic actions such as initiating replication or causing a post-failure switch of mailboxes from a Primary to a Standby Exchange Server can be initiated by a single mouse-click, for anywhere from a single mailbox to potentially ALL mailboxes hosted on the Primary Exchange Server.

4. The invention described in this application (Web Enabled Exchange Server Standby Solution Using Mailbox Level Replication) allows a unique level of flexibility not afforded by any prior Exchange Standby solution, including the ability to have paired Exchange servers acting BOTH as a Primary server hosting their own user mailboxes AND as a Standby Server for mailboxes hosted on the other server.

5. The invention described in this application (Web Enabled Exchange Server Standby Solution Using Mailbox Level Replication) provides a unique level of cost-effectiveness to the solution for organizations having multiple, geographically separated servers and a need to provide a robust, quick and effective disaster recovery capability for e-mail within the organization.

6. The invention described in this application (Web Enabled Exchange Server Standby Solution Using Mailbox Level Replication) allows a unique level of flexibility not afforded by any prior Microsoft Exchange solution for the migration of user mailboxes from one Exchange Server to another with minimal interruption of normal email operations and this provides a unique level of cost-effectiveness during Exchange migration/upgrade.

7. The ability to easily switch operation of user email between servers with a single mouse click without affecting user email operations provided by the invention described in this application (Web Enabled Exchange Server Standby Solution Using Mailbox Level Replication) allows capabilities for easily performing routine maintenance or upgrade operations on Exchange servers which have not previously existed.
